(19) United States
(12) Patent Application Publication
(10) Pub. No.: US 2015/0048212 A1
(43) Pub. Date: Feb. 19, 2015

(54) UNSTEADY AERODYNAMICS MITIGATION FOR MULTI-BODY AEROSPACE APPARATUS

(71) Applicant: The Boeing Company, Chicago, IL (US)

(72) Inventors: Darren Alec Fricker, Fountain Valley, CA (US); Kevin G. Bowcutt, Aliso Viejo, CA (US)

(21) Appl. No.: 13/970,141

(22) Filed: Aug. 19, 2013

(51) Int. Cl. B64G 1/64

(52) U.S. Cl. CPC B64G 1/645
USPC 244/158.1; 29/428

(57) ABSTRACT

A multi-body aerospace apparatus includes a first aerospace body, a second aerospace body, and a flow separation member. The second aerospace body is attached adjacent to the first aerospace body with a gap disposed between the first aerospace body and the second aerospace body. The flow separation member is attached to the first aerospace body or to the second aerospace body.

### FIELD OF THE DISCLOSURE

This disclosure relates to creating a uniform and steady airflow in multi-body aerospace apparatus.

### BACKGROUND

Multi-body aerospace apparatus, such as aircraft, space-shuttles, vehicles, or other types of multi-body aerospace apparatus typically experience unsteady airflow in the areas between the multiple bodies of the multi-body aerospace apparatus. This unsteady airflow load may create stability, load, and control issues for the multi-body aerospace apparatus. To address this issue, multi-body aerospace apparatus are typically made stronger which increases weight and cost.

Multi-body aerospace apparatus and methods for their use are needed to address one or more of the issues associated with one or more of the current multi-body aerospace apparatus.

### SUMMARY

In one embodiment, a multi-body aerospace apparatus is disclosed. The multi-body aerospace apparatus includes a first aerospace body, a second aerospace body attached adjacent to the first aerospace body with a gap disposed between the first aerospace body and the second aerospace body, and a flow separation member attached to the first aerospace body or to the second aerospace body.

In another embodiment, an aerospace body is disclosed which is configured to attach to another aerospace body. The aerospace body includes an attachment member and a flow separation member. The attachment member is attached to the aerospace body which is configured to attach to the another aerospace body so that a gap is disposed between the aerospace body and the another aerospace body. The flow separation member is attached to the aerospace body.

In still another embodiment, a method of using a multi-body aerospace apparatus is disclosed. In one step, a first aerospace body is attached adjacent to a second aerospace body so that a gap is disposed between the first aerospace body and the second aerospace body. In another step, a flow separation member is attached to the first aerospace body or to the second aerospace body.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a perspective view of a multi-body aerospace apparatus;

FIG. 2 illustrates a side-view of a portion of the multi-body aerospace apparatus of FIG. 1;

FIG. 3 illustrates the unsteady airflow which is produced at one point in time as a multi-aerospace apparatus without a flow separation member flies through the atmosphere;

FIG. 4 illustrates the steady airflow which is produced at one point in time as a multi-aerospace apparatus having a flow separation member flies through the atmosphere;

FIG. 5 illustrates a perspective view of another embodiment of a multi-body aerospace apparatus;

FIG. 6 illustrates a side-view of a portion of the multi-body aerospace apparatus of FIG. 5;

FIG. 7 illustrates a perspective view of a multi-body aerospace apparatus;

FIG. 8 illustrates a side-view of a portion of the multi-body aerospace apparatus of FIG. 7; and

FIG. 9 is a flowchart illustrating one embodiment of a method of using a multi-body aerospace apparatus.

### DETAILED DESCRIPTION

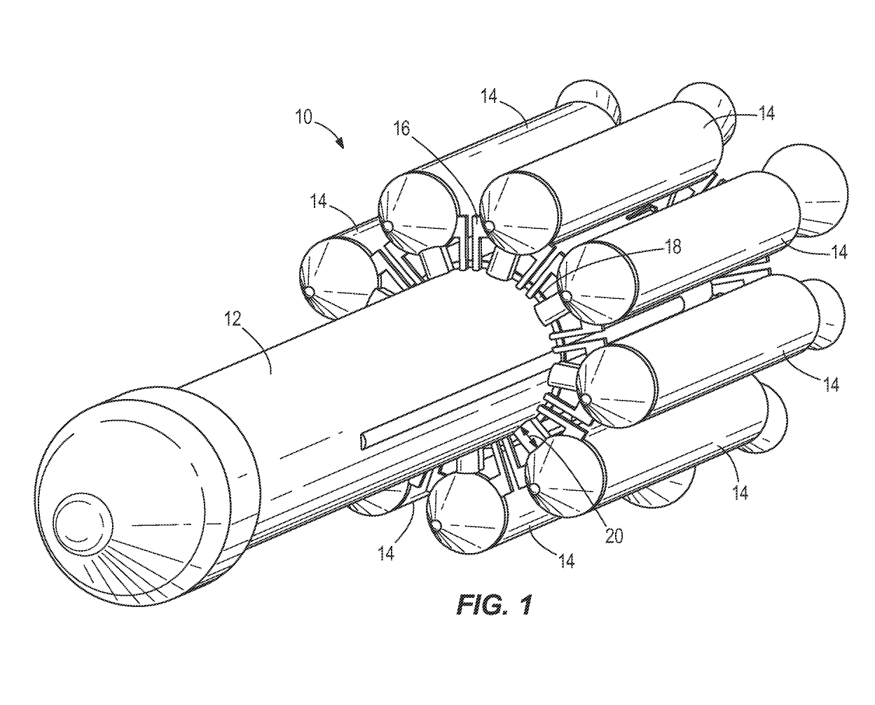

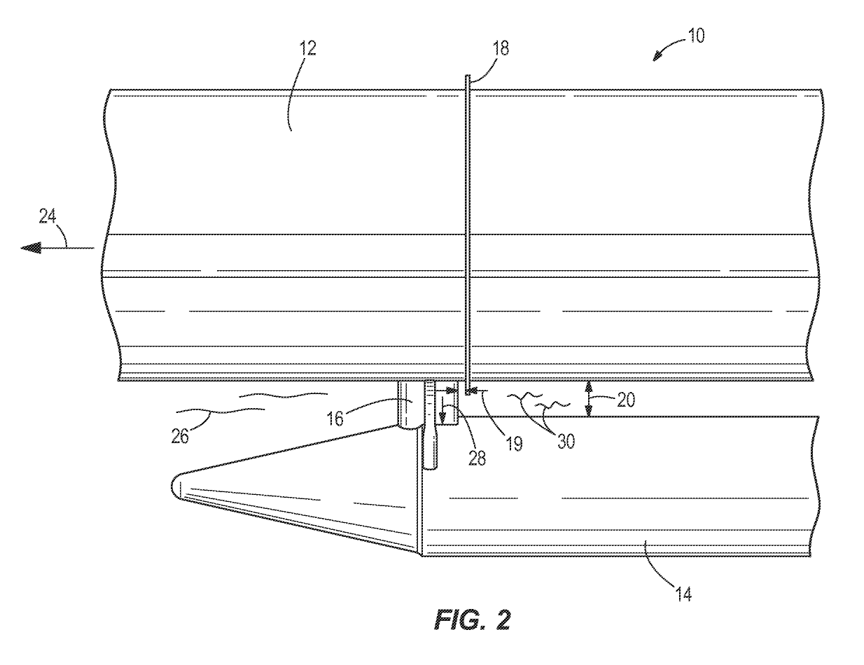

FIG. 1 illustrates a perspective view of a multi-body aerospace apparatus 10. The multi-body aerospace apparatus 10 may comprise any type of multi-body aerospace apparatus 10 for flying through the atmosphere such as an aircraft, a space shuttle, a vehicle, or another type of multi-body aerospace apparatus. The multi-body aerospace apparatus 10 comprises a first aerospace body 12, a second aerospace body 14, an attachment member 16, and a flow separation member 18. The first aerospace body 12 comprises a core body and the second aerospace body 14 may be considered a booster rocket. In this regard, the aerospace apparatus 10 shown in FIG. 1 includes nine second aerospace bodies 14, e.g., nine booster rockets, with one of the nine second aerospace bodies 14 hidden from view. In other embodiments, the first aerospace body 12 and the second aerospace body 14 may comprise varying numbers and types of aerospace bodies. The attachment member 16 attaches the first aerospace body 12 adjacent to the second aerospace body 14 with a gap 20 disposed between the first aerospace body 12 and the second aerospace body 14. The attachment member 16 may be attached to the first aerospace body 12 and to the second aerospace body 14 with any type of attachment mechanism such as fasteners, snap-fits, or other attachment members. The flow separation member 18 is attached to the first aerospace body 12 downstream of the attachment member 16. In this regard, downstream refers to a position that is away from the most forward portion of the multi-body aerospace vehicle 10 as the vehicle flies or travels through the atmosphere in direction 24 shown in FIG. 2. In other embodiments in which the attachment member 16 is located towards a back or downstream end of the first aerospace body 12, the flow separation member 18 may be attached to the first aerospace body 12 upstream of the attachment member 16.

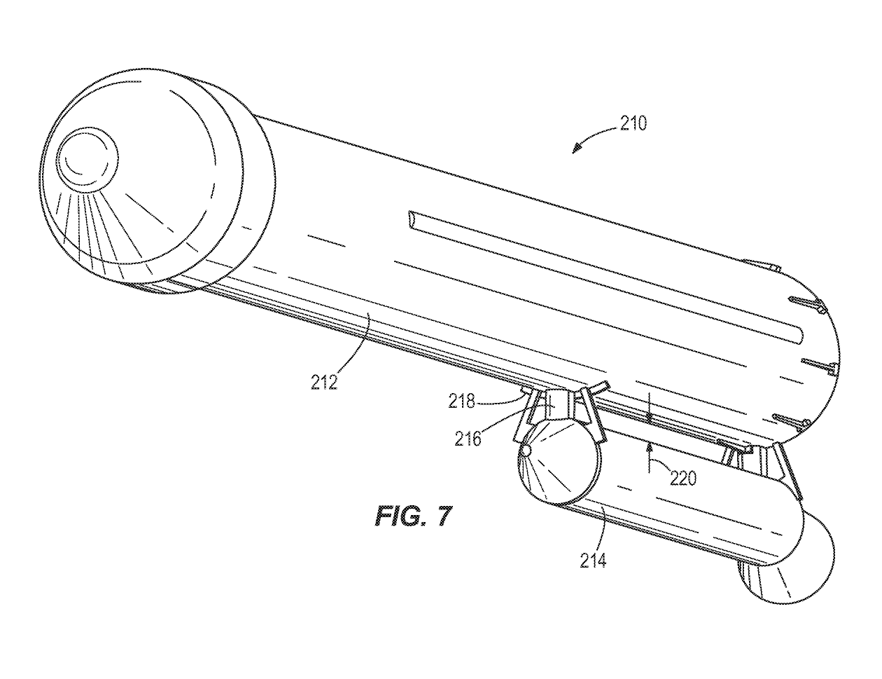

FIG. 2 illustrates a side-view of a portion of the multi-body aerospace apparatus 10 of FIG. 1 showing only one of the second aerospace bodies 14 to better illustrate the flow separation member 18. The flow separation member 18 comprises a ring extending completely around the first aerospace body 12. Alternatively, the flow separation member 18 may include one or more separate portions that form a segmented ring that extends completely around the first aerospace body 12 (see for example the single flow separation member of FIG. 7 that may form one such segmented portion). The flow separation member 18 may be made of metal or varying materials. The flow separation member 18 may be attached to the first aerospace body 12 with any type of attachment mechanism such as fasteners, snap-fits, or other attachment members. The flow separation member 18 is disposed apart by a distance 19 from the attachment member 16. The flow separation member 18 extends in a direction away from the first aerospace body 12 and partway into the gap 20. In other embodiments, the flow separation member 18 may comprise varying materials, shapes, sizes, and configurations. As the multi-body aerospace apparatus 10 travels in direction 24, air 26 traveling downstream first comes in contact with the attachment member 16 and then comes in contact with the flow separation member 18. The flow separation member 18 lifts the air 26 near the core body in direction 28 off the first aerospace body 12 into the gap 20 between the first aerospace body 12 and the second aerospace body 14. This lifting of the air 26 in direction 28, due to the flow separation member 18, off the first aerospace body 12 into the gap 20 produces a uniform and steady airflow 30 between the first aerospace body 12 and the second aerospace body 14. In another embodiment, the flow separation member 18 may be disposed against the attachment member 16. In yet another embodiment, the flow separation member 18 may comprise an integral portion of the attachment member 16.

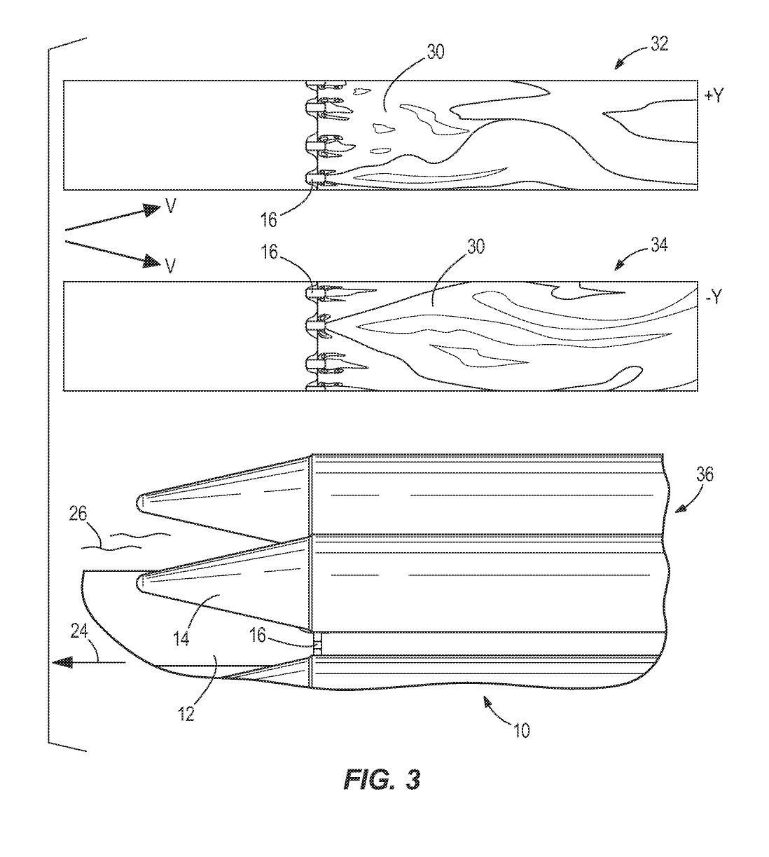

FIG. 3 illustrates the unsteady airflow 30 which is produced at one point in time as a multi-aerospace apparatus 10 without the flow separation member flies in direction 24 through the atmosphere 26. Airflow chart 32 shows the unsteady airflow in the +Y vector and airflow chart 34 shows the unsteady airflow in the −Y vector with both unsteady airflow charts 32 and 34 aligned with the portion of the multi-aerospace apparatus 10 shown in representation 36. The attachment member 16 attaching the first aerospace body 12 to the second aerospace body 14 is shown in each of airflow charts 32 and 34 and in representation 36. As shown in unsteady airflow charts 32 and 34, when the multi-aerospace apparatus 10 does not contain the flow separation member unsteady airflow 30 is produced downstream of the attachment member 16. This unsteady airflow 30 makes it difficult to control flight of the multi-aerospace apparatus 10, creates loads on the multi-aerospace apparatus 10, or creates stability issues. As a result, without the flow separation member the multi-aerospace apparatus 10 has to be made stronger to handle the unsteady airflow 30 which adds weight and cost to the manufacture of the multi-aerospace apparatus 10. It is noted that unsteady airflow 30 is typically most severe in the transonic flow regime which is approximately 0.7<free stream Mach number<1.2.

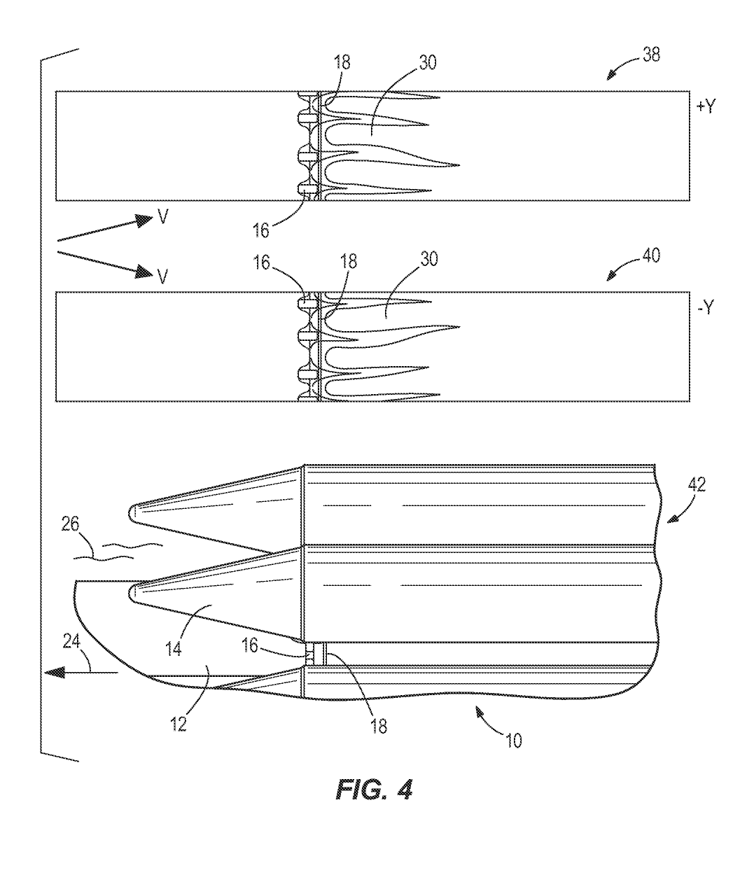

FIG. 4 illustrates the steady airflow 30 which is produced at one point in time as a multi-aerospace apparatus 10 having the flow separation member 18 flies in direction 24 through the atmosphere 26. Airflow chart 38 shows the steady airflow in the +Y vector and airflow chart 40 shows the steady airflow in the −Y vector with both steady airflow charts 38 and 40 aligned with the portion of the multi-aerospace apparatus 10 shown in representation 42. The attachment member 16 attaching the first aerospace body 12 to the second aerospace body 14 is shown in each of airflow charts 38 and 40 and in representation 42. As shown in steady airflow charts 38 and 40, when the multi-aerospace apparatus 10 includes the flow separation member 18 steady airflow 30 is produced downstream of the attachment member 16. This steady airflow 30 makes it relatively easier to control flight of the multi-aerospace apparatus 10 and reduces the loads on the multi-aerospace apparatus 10 when compared to the multi-aerospace apparatus without the flow separation member 18. As a result, due to the flow separation member 18 the multi-aerospace apparatus 10 can be made lighter with substantially the same performance characteristics which reduces weight and cost to the manufacture of the multi-aerospace apparatus 10.

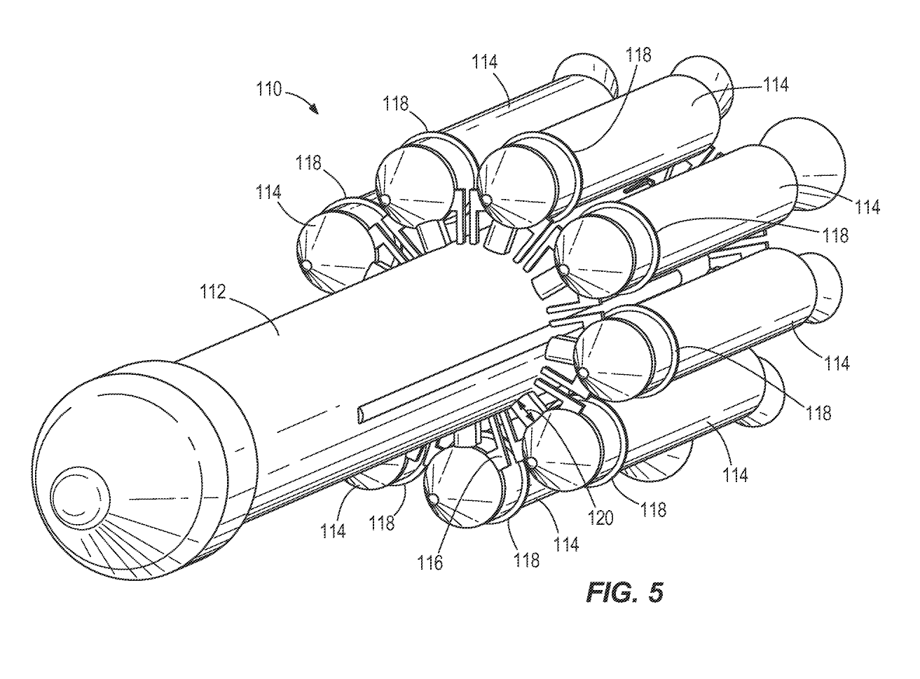

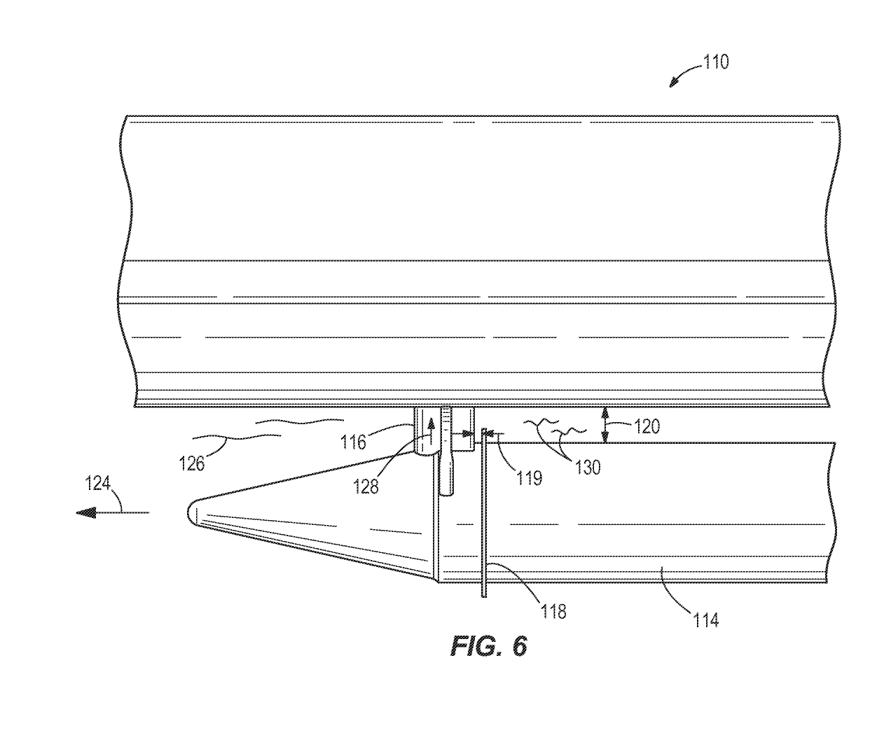

FIG. 5 illustrates a perspective view of another embodiment of a multi-body aerospace apparatus 110. The multi-body aerospace apparatus 110 may comprise any type of multi-body aerospace apparatus 110 for flying or traveling through the atmosphere. The multi-body aerospace apparatus 110 comprises a first aerospace body 112, a second aerospace body 114, an attachment member 116, and a flow separation member 118. The first aerospace body 112 comprises a core body. The second aerospace body 114 may be considered a booster rocket. In this regard, the aerospace apparatus 110 shown in FIG. 5 includes nine second aerospace bodies 114, e.g., nine booster rockets with one of the nine second aerospace bodies 114 hidden from view. In other embodiments, the first aerospace body 112 and the second aerospace body 114 may comprise varying numbers and types of aerospace bodies. The attachment member 116 attaches the first aerospace body 112 adjacent to the second aerospace body 114 with a gap 120 disposed between the first aerospace body 112 and the second aerospace body 114. The attachment member 116 may be attached to the first aerospace body 112 and to the second aerospace body 114 with any type of attachment mechanism such as fasteners, snap-fits, or other attachment members. The flow separation member 118 is attached to the second aerospace body 114 downstream of the attachment member 116. In this regard, downstream refers to a position that is away from the most forward portion of the multi-body aerospace vehicle 110 as the vehicle flies or travels through the atmosphere in direction 124 shown in FIG. 6. In other embodiments in which the attachment member 116 is located towards a back end of the first aerospace body 112, the flow separation member 118 may be attached to the second aerospace body 114 upstream of the attachment member 116.

FIG. 6 illustrates a side-view of a portion of the multi-body aerospace apparatus 110 of FIG. 5 showing only one of the second aerospace body 114 to better illustrate the flow separation member 118. The flow separation member 118 comprises a ring extending around the second aerospace body 114. It is noted, as shown in FIG. 5, that each of the nine second aerospace bodies 114 include a separate ring comprising the flow separation member 118 extending completely around the corresponding second aerospace body 114. In another embodiment, the flow separation member 118 may extend partially around the second aerospace body 114 to extend into the gap 120 disposed between the first aerospace body 112 and the second aerospace body 114. The following description related to flow separation member 118 attached to the one rocket booster shown in FIG. 6 applies identically to each of the flow separation members 118 attached to the remaining eight rocket boosters shown in FIG. 5.

The flow separation member 118 may be made of metal or varying materials. The flow separation member 118 may be attached to the second aerospace body 114 with any type of attachment mechanism such as fasteners, snap-fits, or other attachment members. The flow separation member 118 is disposed apart by a distance 119 from the attachment member 116. The flow separation member 118 extends in a direction away from the second aerospace body 114 and partway into the gap 120. In other embodiments, the flow separation member 118 may comprise varying materials, shapes, sizes, and configurations. As the multi-body aerospace apparatus 110 travels in direction 124, air 126 traveling downstream first comes in contact with the attachment member 116 and then comes in contact with the flow separation member 118. The flow separation member 118 lifts the air 126 in direction 128 off the second aerospace body 114 toward the first aerospace body 112 and into the gap 120 between the first aerospace body 112 and the second aerospace body 114.

This lifting of the air 126 in direction 128, due to the flow separation member 118, off the second aerospace body 114 into the gap 120 produces a uniform and steady airflow 130 between the first aerospace body 112 and the second aerospace body 114. As shown in FIG. 5, since each of the second aerospace bodies 114 contain a corresponding separate flow separation members 118, uniform and steady airflow 130 (shown in FIG. 6) is created between each of the second aerospace bodies 114 and the first aerospace body 112 creating a symmetric, uniform, steady airflow around the multi-body aerospace apparatus 110. In another embodiment, the flow separation member 118 may be disposed against the attachment member 116. In yet another embodiment, the flow separation member 118 may comprise an integral portion of the attachment member 116.

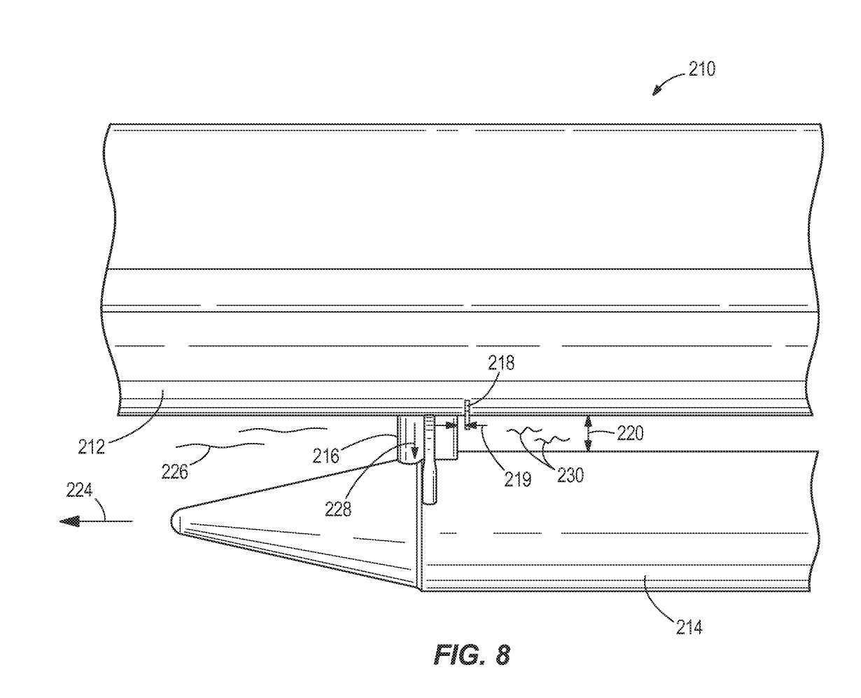

FIG. 7 illustrates a perspective view of a multi-body aerospace apparatus 210. The multi-body aerospace apparatus 210 may comprise any type of multi-body aerospace apparatus 210 for flying or traveling through the atmosphere. The multi-body aerospace apparatus 210 comprises a first aerospace body 212, a second aerospace body 214, an attachment member 216, and a flow separation member 218. The first aerospace body 212 comprises a core body and the second aerospace body 214 comprises one booster rocket. In other embodiments, the first aerospace body 212 and the second aerospace body 214 may comprise varying numbers and types of aerospace bodies. The attachment member 216 attaches the first aerospace body 212 adjacent to the second aerospace body 214 with a gap 220 disposed between the first aerospace body 212 and the second aerospace body 214. The attachment member 216 may be attached to the first aerospace body 212 and to the second aerospace body 214 with any type of attachment mechanism such as fasteners, snap-fits, or other attachment members. The flow separation member 218 is attached to the first aerospace body 212 downstream of the attachment member 216. In this regard, downstream refers to a position that is away from the most forward portion of the multi-body aerospace vehicle 210 as the vehicle flies or travels through the atmosphere in direction 224 shown in FIG. 8. In other embodiments in which the attachment member 216 is located towards a back end of the first aerospace body 212, the flow separation member 218 may be attached to the first aerospace body 212 upstream of the attachment member 216.

FIG. 8 illustrates a side-view of a portion of the multi-body aerospace apparatus 210 of FIG. 7 showing the second aerospace body 214 to better illustrate the flow separation member 218. The flow separation member 218 comprises a curved member extending only partway or partially around a perimeter of the first aerospace body 212. It is noted that the flow separation member 218 is larger in length than the attachment member 216 and covers the entire length of the attachment member 216 to assure steady uniform and steady airflow 230 over the entire attachment member 216. Since the attachment member 216 only extends partway around the perimeter of the first aerospace body 212, the flow separation member 218 only needs to extend partway around the perimeter of the first aerospace body 212 at the location of the attachment member 216 to create the uniform and steady airflow 230. The flow separation member 218 may be made of metal or varying materials. The flow separation member 218 may be attached to the first aerospace body 212 with any type of attachment mechanism such as fasteners, snap-fits, or other attachment members. In another embodiment, the flow separation member 218 may be attached to the second aerospace body 214 and only extend partway around the perimeter of the second aerospace body 214 at the location of the attachment member 216 to create the uniform and steady airflow 230.

The flow separation member 218 is disposed apart by a distance 219 from the attachment member 216. The flow separation member 218 extends in a direction away from the first aerospace body 112 and partway into the gap 220. In other embodiments, the flow separation member 218 may comprise varying materials, shapes, sizes, and configurations. As the multi-body aerospace apparatus 210 travels in direction 224, air 226 traveling downstream first comes in contact with the attachment member 216 and then comes in contact with the flow separation member 218. The flow separation member 218 lifts the air 226 in direction 228 off the first aerospace body 212 into the gap 220 between the first aerospace body 212 and the second aerospace body 214. This lifting of the air 226 in direction 228, due to the flow separation member 218, off the first aerospace body 212 toward the second aerospace body 214 and into the gap 220 produces a relatively more uniform and steady airflow 230 between the first aerospace body 212 and the second aerospace body 214 when compared to the multi-aerospace apparatus without the flow separation member 218. In another embodiment, the flow separation member 218 may be disposed against the attachment member 216. In yet another embodiment, the flow separation member 218 may comprise an integral portion of the attachment member 216.

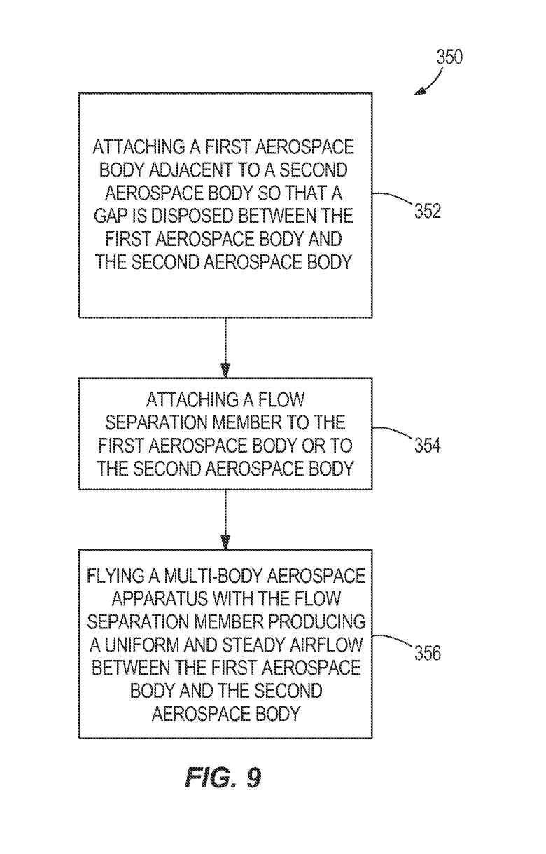

FIG. 9 is a flowchart illustrating one embodiment of a method 350 of using a multi-body aerospace apparatus. The method 350 may utilize any of the embodiments of the multi-body aerospace apparatus disclosed herein. In step 352, a first aerospace body is attached adjacent to a second aerospace body so that a gap is disposed between the first aerospace body and the second aerospace body. In one embodiment, step 352 may further comprise attaching the first aerospace body adjacent to the second aerospace body with an attachment member so that the gap is disposed between the first aerospace body and the second aerospace body. In one embodiment, the first aerospace body comprises a core body and the second aerospace body comprises one or more rocket boosters. In other embodiments, the first aerospace body and the second aerospace body may vary.

In step 354, a flow separation member is attached to the first aerospace body or to the second aerospace body. In one embodiment, the attachment member and the flow separation member are separate parts. In another embodiment, the flow separation member may comprise an integral portion of the attachment member and steps 352 and 354 may comprise one step. The flow separation member may comprise a ring. In other embodiments, the flow separation member may vary. In one embodiment, step 354 may further comprise disposing the flow separation member apart from the attachment member. In another embodiment, step 354 may further comprise disposing the flow separation member against the attachment member. In one embodiment, step 354 may further comprise the flow separation member extending partway into the gap. In still another embodiment, step 354 may further comprise the flow separation member extending partway around a perimeter of the first aerospace body or the second aerospace body. In one embodiment, step 354 may comprise disposing the flow separation member downstream from the attachment member. In another embodiment, step 354 may comprise disposing the flow separation member upstream from the attachment member. In step 356, the multi-body aerospace apparatus is flown with the flow separation member producing a uniform and steady airflow between the first aerospace body and the second aerospace body. In other embodiments, any of the steps of the method 350 may be varied in substance or in order, one or more of the steps may not be followed, or one or more additional steps may be added.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A multi-body aerospace apparatus comprising:
a first aerospace body;
a second aerospace body attached adjacent to the first aerospace body with a gap disposed between the first aerospace body and the second aerospace body; and
a flow separation member attached to the first aerospace body or the second aerospace body.

2. The multi-body aerospace apparatus of claim 1 wherein the flow separation member is configured to produce a uniform and steady airflow between the first aerospace body and the second aerospace body.

3. The multi-body aerospace apparatus of claim 1 further comprising an attachment member attaching the first aerospace body adjacent to the second aerospace body with the gap disposed between the first aerospace body and the second aerospace body, wherein the flow separation member comprises a separate part than the attachment member.

4. The multi-body aerospace apparatus of claim 3 wherein the flow separation member is disposed apart from the attachment member.

5. The multi-body aerospace apparatus of claim 3 wherein the flow separation member is disposed against the attachment member.

6. The multi-body aerospace apparatus of claim 1 wherein the flow separation member comprises an integral portion of an attachment member attaching the first aerospace body adjacent to the second aerospace body with the gap disposed between the first aerospace body and the second aerospace body.

7. The multi-body aerospace apparatus of claim 1 wherein the flow separation member comprises a ring.

8. The multi-body aerospace apparatus of claim 1 wherein the flow separation member extends partway around a perimeter of the first aerospace body or the second aerospace body.

9. The multi-body aerospace apparatus of claim 1 wherein the flow separation member extends partway into the gap.

10. The multi-body aerospace apparatus of claim 1 wherein the first aerospace body comprises a core body and the second aerospace body comprises a rocket booster.

11. An aerospace body configured to attach to another aerospace body comprising:
an attachment member attached to the aerospace body which is configured to attach to the another aerospace body so that a gap is disposed between the aerospace body and the another aerospace body; and
a flow separation member attached to the aerospace body.

12. The aerospace body of claim 11 wherein the flow separation member is configured to produce a uniform and steady airflow between the aerospace body and the another aerospace body.

13. The aerospace body of claim 11 wherein the flow separation member comprises a separate part than the attachment member and the flow separation member is disposed apart from the attachment member.

14. The aerospace body of claim 11 wherein the flow separation member comprise a separate part than the attachment member and the flow separation member is disposed against the attachment member.

15. The aerospace body of claim 11 wherein the flow separation member comprises an integral portion of the attachment member.

16. The aerospace body of claim 11 wherein the flow separation member comprises a ring.

17. The aerospace body of claim 11 wherein the flow separation member extends partway around a perimeter of the aerospace body.

18. The aerospace body of claim 11 wherein the flow separation member extends partway into the gap.

19. The aerospace body of claim 11 wherein the aerospace body comprises a core body or a rocket booster.

20. A method of using a multi-body aerospace apparatus comprising:
attaching a first aerospace body adjacent to a second aerospace body so that a gap is disposed between the first aerospace body and the second aerospace body; and
attaching a flow separation member to the first aerospace body or the second aerospace body.

21. The method of claim 20 further comprising flying the multi-body aerospace apparatus with the flow separation member producing a uniform and steady airflow between the first aerospace body and the second aerospace body.

22. The method of claim 20 wherein the attaching the first aerospace body adjacent to the second aerospace body further comprises attaching the first aerospace body adjacent to the second aerospace body with an attachment member so that the gap is disposed between the first aerospace body and the second aerospace body, wherein the flow separation member comprises a separate part than the attachment member.

23. The method of claim 22 wherein the attaching the flow separation member to the first aerospace body or to the second aerospace body further comprises disposing the flow separation member apart from the attachment member.

24. The method of claim 22 wherein the attaching the flow separation member to the first aerospace body or to the second aerospace body further comprises disposing the flow separation member against the attachment member.

25. The method of claim 20 wherein the attaching the first aerospace body adjacent to the second aerospace body further comprises attaching the first aerospace body adjacent to the second aerospace body with an attachment member so that the gap is disposed between the first aerospace body and the second aerospace body, wherein the flow separation member comprises an integral portion of the attachment member.

26. The method of claim 20 wherein the flow separation member comprises a ring.

27. The method of claim 20 wherein the attaching the flow separation member to the first aerospace body or to the second aerospace body further comprises the flow separation member extending partway around a perimeter of the first aerospace body or the second aerospace body.

28. The method of claim 20 wherein the attaching the flow separation member to the first aerospace body or to the second aerospace body further comprises the flow separation member extending partway into the gap.

29. The method of claim 20 wherein the first aerospace body comprises a core body and the second aerospace body comprises a rocket booster.
